(19) United States
(12) Patent Application Publication
(10) Pub. No.: US 2022/0170228 A1
(43) Pub. Date: Jun. 2, 2022

(54) METHOD FOR MANUFACTURING FOUNDATION

(71) Applicant: JGC CORPORATION, Kanagawa (JP)

(72) Inventors: Hiroteru IGARASHI, Kanagawa (JP); Noriaki TERAKUBO, Kanagawa (JP); Atsuo HONIDEN, Kanagawa (JP)

(73) Assignee: JGC CORPORATION, Kanagawa (JP)

(21) Appl. No.: 17/442,606

(22) PCT Filed: Jul. 11, 2019
(86) PCT No.: PCT/JP2019/027535

§ 371 Date: Sep. 23, 2021

(51) Int. Cl. E02D 27/00; B29C 64/141

(52) U.S. Cl. CPC E02D 27/00; B33Y 80/00; B29C 64/141

(57) ABSTRACT

To provide a technology for manufacturing a foundation of a plant efficiently and safely. Provided is a method for manufacturing a foundation (6) to be provided in a plant configured to process fluid, the method including a step of forming a foundation, by a 3D printer, in a ground for installation of a device to be provided in the plant, or in a ground for installation of a framework structure configured to support the device or a piping through which the fluid flows, the foundation being configured to support the device or the framework structure.

### TECHNICAL FIELD

The present invention relates to a technology for constructing a plant.

### BACKGROUND ART

Examples of a plant for processing fluid include a natural gas plant for liquefying natural gas and separating/recovering a natural gas liquid, a petroleum refining plant for distilling and desulfurizing crude oil or various intermediate products, and a chemical plant for producing a petrochemical product, an intermediate chemical product, and a polymer.

As described in Patent Literature 1, those plants have a structure in which a group of a large number of devices including static devices, such as columns, tanks, and heat exchangers, dynamic devices, such as pumps, and piping provided among those static devices and dynamic devices, are arranged.

In an initial stage of construction work of a plant, in the ground of a construction site, a foundation is formed so as to stably support a framework on which the above-mentioned group of devices is to be arranged, or a large-sized device to be directly arranged on the ground. Accordingly, in order to shorten a construction period for the plant, it is a first point to form the foundation as efficiently as possible. Further, at the same time, there have been demands for reducing the number of plant construction workers and improving safety in a working environment.

### CITATION LIST

### Patent Literature

[Patent Literature 1] WO 2014/028961 A1

### SUMMARY OF INVENTION

### Technical Problem

The present invention provides a technology for manufacturing a foundation of a plant efficiently and safely.

### Solution to Problem

According to the present invention, there is provided a method for manufacturing a foundation to be provided in a plant configured to process fluid, the method including a step of forming a foundation, by a 3D printer, in a ground for installation of a device to be provided in the plant, or in a ground for installation of a framework structure configured to support the device or a piping through which the fluid flows, the foundation being configured to support the device or the framework structure.

The method for manufacturing a foundation may have the following features.

(a) The foundation has a reinforced-concrete (RC) structure, and, in the step of forming a foundation, the foundation having the RC structure is integrally formed through different material joining of a concrete material and a metal material.

(b) In the step of forming a foundation, a flow path, through which the fluid to be used in the plant flows, is formed in the foundation. The flow path is made of a material different from a constituent material for the foundation, and the flow path is integrally formed in the foundation through different material joining of the constituent material for the foundation and a constituent material for the flow path performed through use of the 3D printer.

(c) An inside of the foundation has a sparse structure obtained by combining members in a geometric pattern.

### Advantageous Effects of Invention

According to the method of the present invention, the foundation is manufactured through use of the 3D printer. Thus, manufacture of each foundation is automated. Accordingly, the forming work of the foundation can be performed efficiently while the work performed by the construction workers is reduced and safety is improved.

### BRIEF DESCRIPTION OF DRAWINGS

FIG. 1 is a perspective view for illustrating an overall configuration of a plant.

FIG. 2 is a plan view for illustrating an outline of a plot plan of the plant.

FIG. 3 are plan views for illustrating an outline of a plot plan of a part of an area of the plant, and an outline of arrangement of foundations.

FIG. 4 is a side view for illustrating the entirety of a 3D printer configured to manufacture the foundations of the plant.

FIG. 5 is a first explanatory view for illustrating steps of manufacturing the foundation having an RC structure.

FIG. 6 is a second explanatory view for illustrating the steps of manufacturing the foundation having the RC structure.

FIG. 7 is a third explanatory view for illustrating the steps of manufacturing the foundation having the RC structure.

FIG. 8 is a plan view for illustrating an example of arrangement of the foundations in the vicinity of a processing column.

FIG. 9 are first explanatory views for illustrating steps of manufacturing a foundation with a flow path.

FIG. 10 are second explanatory views for illustrating the steps of manufacturing the foundation with a flow path.

FIG. 11 is a plan view for illustrating a configuration example of a processing column foundation configured to support the processing column.

### DESCRIPTION OF EMBODIMENTS

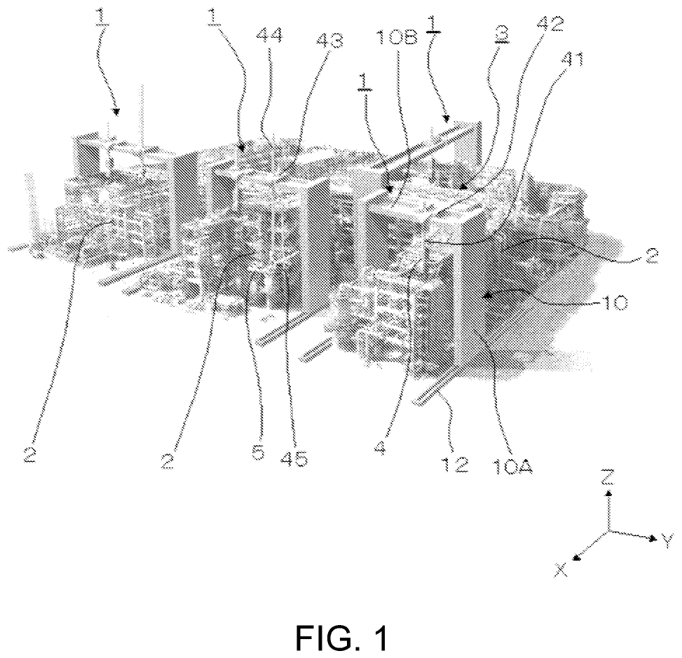

FIG. 1 is a perspective view for illustrating the entirety of a plant constructed by a 3D printer (additive manufacturing device) 1. As illustrated in FIG. 1, most of components of the plant, such as devices, piping, and a framework, will be able to be formed by the 3D printer 1 in the near future. In the subject application, as an elemental technology, description is made of an example of forming, through use of the 3D printer 1, a foundation configured to support devices to be installed in the plant, or a foundation configured to support a framework structure that supports the devices and the piping.

Here, currently, patents have been granted for technologies for manufacturing, by the 3D printer, large-sized members such as aircraft fuselage parts and wings (for example, Japanese Patent No. 6513554), and building materials (for example, Japanese Patent No. 6378699). Further, based on, for example, investigations of development circumstances of 3D printer manufacturers, the inventors of the subject application have grasped that the 3D printer capable of forming a large structure can be provided when there are demands from consumers.

The plant illustrated in FIG. 1 is, for example, a plant configured to manufacture liquefied natural gas (LNG) being fluid, and includes a large number of devices 2 configured to perform liquefaction pre-processing and liquefaction of the pre-processed natural gas. Further, by the side of an installation region for each device 2, there is provided a pipe rack 3 being a framework structure configured to support pipings for allowing various kinds of fluid, which are to be used in the LNG plant, to be transferred among the devices 2.

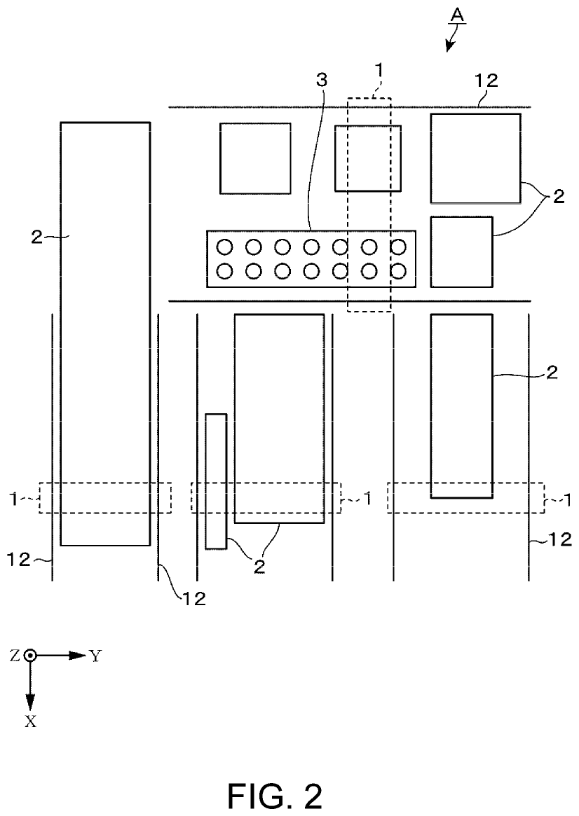

As schematically illustrated in a plan view of FIG. 2, for the LNG plant in one embodiment of the present invention, a construction site is divided into a plurality of sections, and the 3D printer 1 is installed in each section. Thus, the LNG plant is constructed in that region.

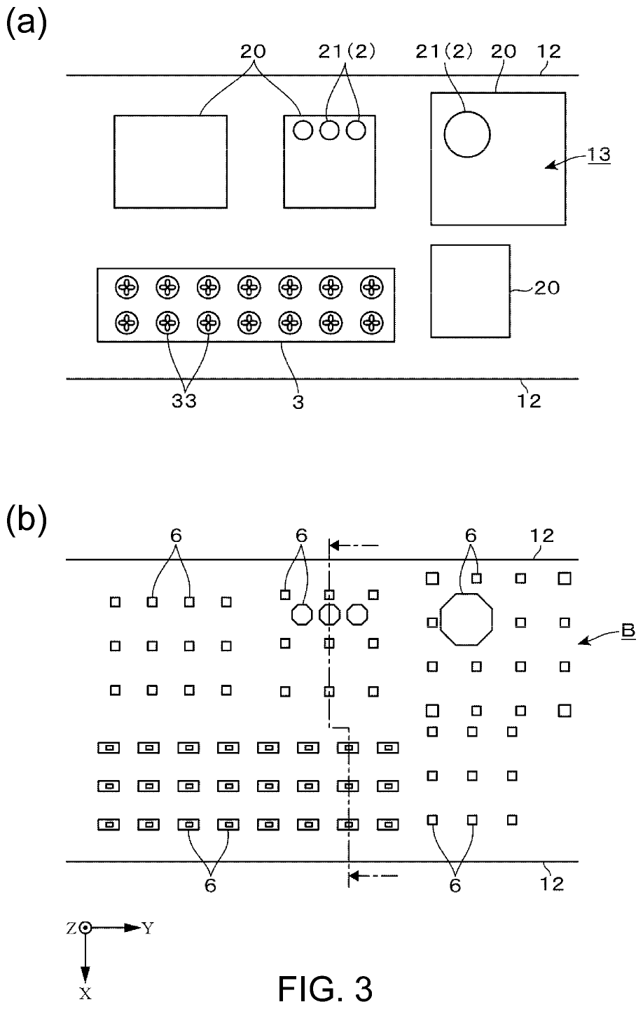

FIG. 3 are enlarged views for illustrating the section indicated by the reference symbol “A” in FIG. 2. As schematically illustrated in (a) of FIG. 3, in the section, a large number of devices 2 being components of the LNG plant are collectively arranged in device racks 20. For example, each device rack 20 is configured as a framework structure having a plurality of floors, and the devices 2 being components of the LNG plant are arranged on the floors.

Further, large-sized devices 21, such as a main cryogenic heat exchanger (MCHE) for liquefying and supercooling natural gas and a fractionator of a type among various types, are arranged so as to pass through the plurality of floors of the device rack 20 in an up-and-down direction, or arranged outside the device rack 20 in some cases.

Moreover, in the section illustrated in (a) of FIG. 3, the pipe rack 3 described above is also arranged.

The device racks 20, the large-sized devices 21, and the pipe rack 3 are supported on the ground through intermediation of foundations 6 laid in the construction site. In FIG. 3, (b) is a plan view for schematically illustrating an arrangement example of the foundations 6 configured to support the device racks 20, the large-sized devices 21, and the pipe rack 3.

As illustrated in (b) of FIG. 3, in order to arrange the racks 20 and 3 of various types and the large-sized devices 21 on the ground, it is required to lay a large number of the foundations 6. Hitherto, the foundations 6 have been formed by the following casting work. Specifically, a formwork is placed in a foundation hole dug in the ground, and reinforcing bars are arranged as needed. After that, ready-mixed concrete is poured into the formwork, and solidification of concrete is awaited.

However, the number of the foundations 6 to be laid in the entire LNG plant is extremely large. Thus, repetition of the above-mentioned casting work for forming the foundations 6 has been a considerable constraint in shortening a construction schedule for the LNG plant. Further, it has been required that work, such as placement of the formwork and demolition work, be performed by construction workers.

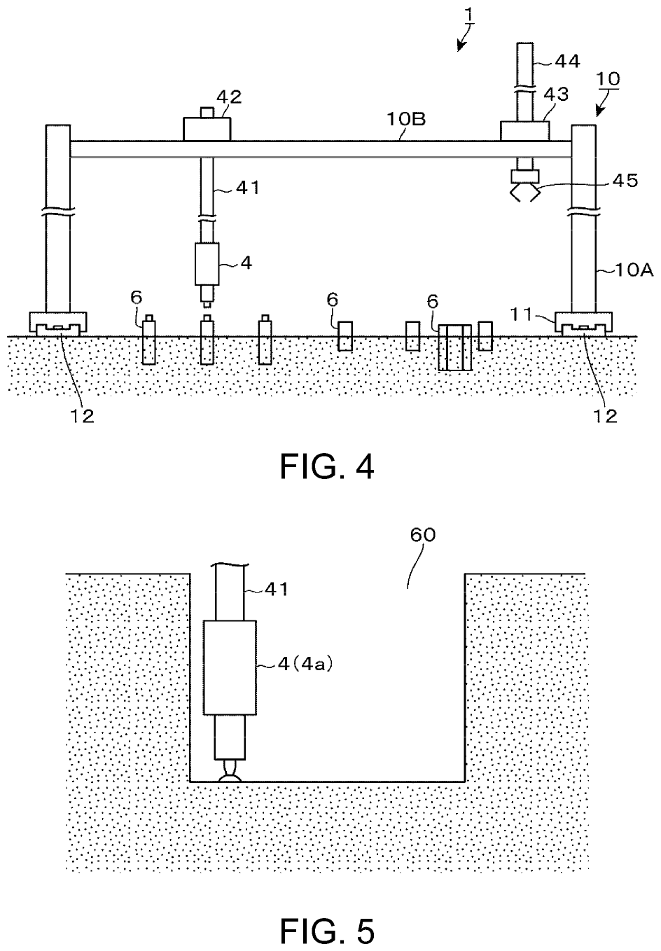

Therefore, in the LNG plant in the embodiment of the present invention, as illustrated in FIG. 4, the various foundations 6 described above are manufactured through use of the 3D printer 1.

As illustrated in FIG. 1 and FIG. 4, the 3D printer 1 in the embodiment of the present invention includes a gate-shaped support unit 10 including a beam portion 10B, and two support pillars 10A supporting both ends of the beam portion 10B. For example, the support unit 10 is provided so as to be capable of straddling the above-mentioned device rack 20 or pipe rack 3 provided in the LNG plant, or an installation region for the large-sized device 21 from above. Further, at a lower end of the support unit 10, there is provided a support unit moving mechanism 11 configured to move the support unit 10. The support unit moving mechanism 11 is freely movable along guide rails 12 that are provided on the ground so as to extend in a direction orthogonal to an extending direction of the beam portion 10B.

Moreover, on the beam portion 10B, a moving member 42 is provided so as to be freely movable along the beam portion 10B. Further, the moving member 42 includes a shaft portion 41 extending downward. At a lower end of the shaft portion 41, there is provided a printer main body 4 configured to perform 3D printing by ejecting downward a material for forming, for example, the foundations 6. The support unit 10 is moved along the guide rails 12, the moving member 42 is moved along the beam portion 10B, and the printer main body 4 is moved up and down along the shaft portion 41. Thus, the printer main body 4 is freely movable in front-and-rear, right-and-left, and up-and-down directions.

Further, the 3D printer 1 may include an arm moving member 43 that is moved along the beam portion 10B. The arm moving member 43 includes a shaft portion 44 extending downward. At a lower end of the shaft portion 44, an arm 45 is provided. The arm 45 is configured to receive a member such as a pipe material, from an outside, and then convey the member to an arrangement position. Similarly to the printer main body 4, the arm 45 is also freely movable in the front-and-rear, right-and-left, and up-and-down directions.

As the printer main body 4, there can be given a case which employs a directional energy deposition method, and in which a constituent material such as ready-mixed concrete, metal powder, or a resin ejected from a nozzle is laminated and accumulated from a lower layer side to form an object. As a matter of course, the 3D printer 1 employing a method different from the directional energy deposition method may also be used. Further, as in a case of a main body 4a for concrete and a main body 4b for metal to be described later, the 3D printer 1 may include a plurality of printer main bodies 4 that can feed different constituent materials, respectively, and can be individually moved through the moving member 42 and the shaft portion 41.

The 3D printer 1 having the configuration described above can be used for manufacture of the various devices and structures to be provided in the LNG plant. In the following example, description is made of an example in which the 3D printer 1 is applied to manufacture of the foundations 6.

FIG. 5 to FIG. 7 are explanatory views for illustrating steps of manufacturing the foundation 6 having an RC structure (hereinafter, also referred to as “RC structure foundation 61”).

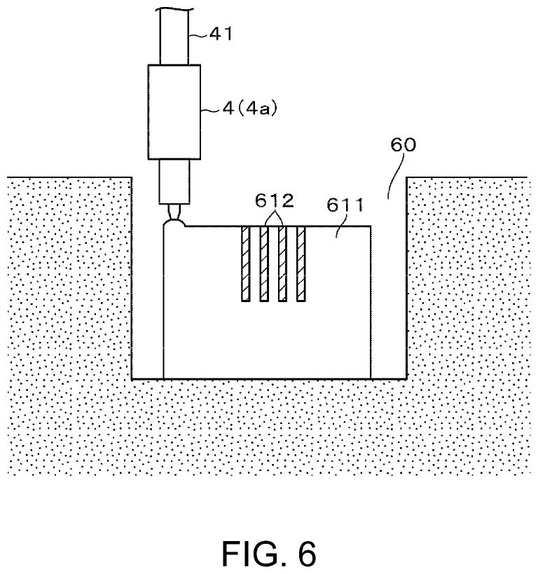

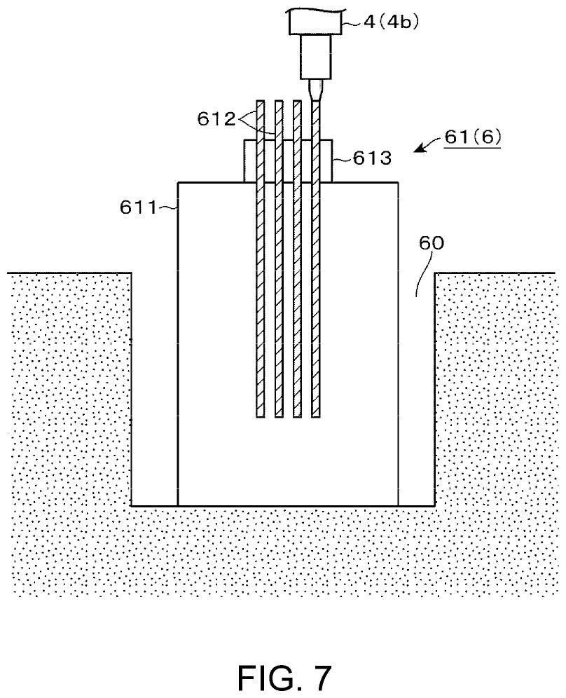

In the conventional manner of forming the RC structure foundation 61, there has been sequentially performed casting work of placing the formwork, arranging reinforcing bar members 612 in the formwork, and pouring ready-mixed concrete into the formwork. In contrast, in a case of employing different material joining performed through use of the plurality of kinds of printer main bodies 4 (the main body 4a for concrete illustrated in FIG. 5 and FIG. 6, and the metal material main body 4b illustrated in FIG. 7), a foundation main part 611 and the reinforcing bar members 612 being reinforcing members can be integrally formed.

First, in the ground of the construction site in which the foundation main part 611 is to be laid, a foundation hole 60 is dug, and an inside of the foundation hole 60 is tamped down. After that, the main body 4a for concrete is caused to enter the foundation hole 60, and concrete being a constituent material for the foundation main part 611 is laminated from a bottom surface of the foundation hole 60 (FIG. 5). Thus, forming of the foundation main part 611 proceeds while solidification of the concrete progresses. At this time, during a period from lamination of the concrete before solidification of the concrete, the 3D printer 1 may perform operation of forming other foundations 6 by performing manufacture of the large number of foundations 6 illustrated in (b) of FIG. 3 in parallel.

When the foundation main part 611 reaches a height position at which the reinforcing bar members 612 are to be formed, at the position of forming the reinforcing bar members 612, feeding of a metal material is performed through use of the main body 4b for metal. Further, around the position of forming the reinforcing bar members 612, forming of the foundation main part 611 through use of the main body 4a for concrete is continued.

Through the above-mentioned operation, as illustrated in FIG. 6, the foundation main part 611 containing the reinforcing bar members 612 is gradually formed (FIG. 6).

When the foundation main part 611 is accumulated to a preset height position above the ground, a connection portion 613 to be connected to a leg portion of the pipe rack 3 or the device rack 20 is formed, and the reinforcing bar members 612 are formed so as to protrude from an upper surface of the connection portion 613.

Through the above-mentioned operation performed through use of the 3D printer 1, the RC structure foundation 61 reinforced by the reinforcing bar members 612 can be integrally formed. Finally, a gap between the RC structure foundation 61 and a side wall of the foundation hole 60 is filled with earth and sand, and, for example, compaction is performed. Thus, laying of the RC structure foundation 61 (foundation 6) is completed.

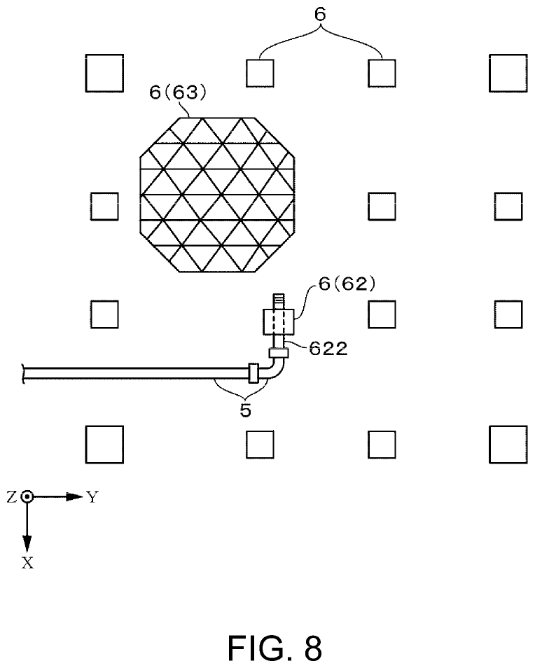

Next, a method for manufacturing the foundations 6 of another kind is described with reference to FIG. 8 to FIG. 11. FIG. 8 is an enlarged plan view for illustrating arrangement of the foundations 6 for the device racks 20 and the large-sized devices 21 to be installed in the region indicated by the reference symbol “B” in FIG. 3.

As illustrated in FIG. 8, in the construction site for the LNG plant, in parallel with laying of the foundations 6, there is performed laying work of a piping 5 to be arranged below the device rack 20.

In the related-art method, when there is a fear in that an arrangement layout of the piping 5 interferes with an arrangement position of the foundation 6, it has been required that the piping 5 be arranged in a roundabout manner aside from the foundation 6 in the process of casting work, or casting work of the foundation 6 be performed under a state in which the piping 5 that is prepared in advance is arranged through the formwork. However, in the former case, the piping 5 having an additional length accompanied with the roundabout arrangement is required. Further, in the latter case, for example, arranging work of the piping 5 in the formwork is required, or a sealing structure is required for preventing leakage of ready-mixed concrete from the formwork through which the piping 5 is arranged. That is, there are required special countermeasures accompanied with arrangement of the piping 5 through the formwork.

In this respect, in a case of using the 3D printer 1 capable of performing the different material joining, there can be integrally formed a foundation 62 with a flow path in which a piping portion 622 is arranged at a preset position.

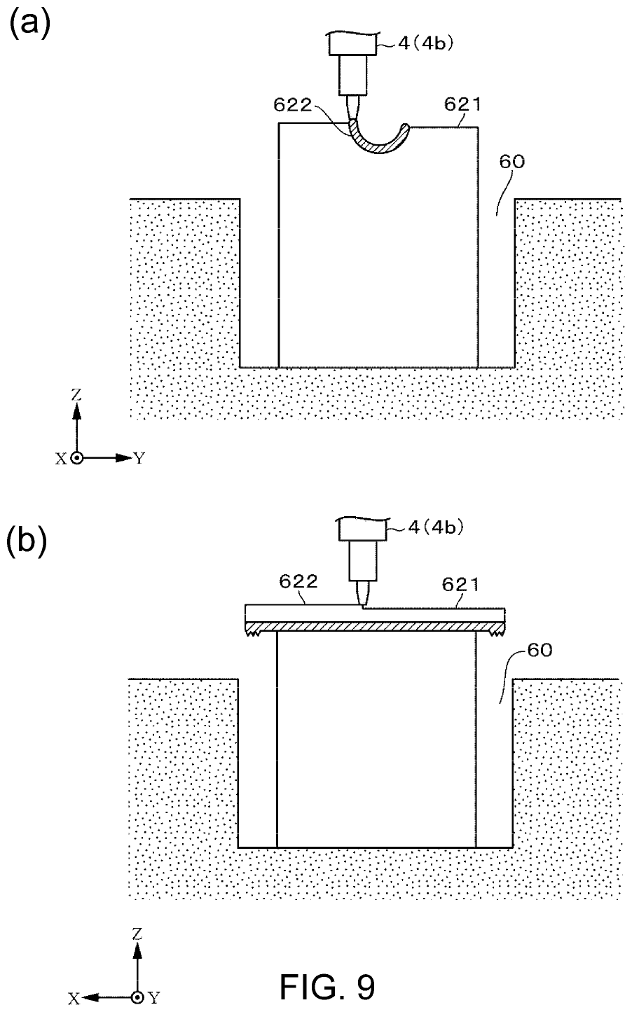

For example, as illustrated in (a) and (b) of FIG. 9, a foundation main part 621 is formed to a preset height position. After that, at the position of forming the piping portion 622, feeding of a metal material is performed through use of the main body 4b for metal. Further, around the position of forming the piping portion 622, forming of the foundation main part 621 through use of the main body 4a for concrete is continued. Through the above-mentioned operation, as illustrated in FIG. 6, the foundation main part 621 containing the piping portion 622 is gradually formed ((a) and (b) of FIG. 9).

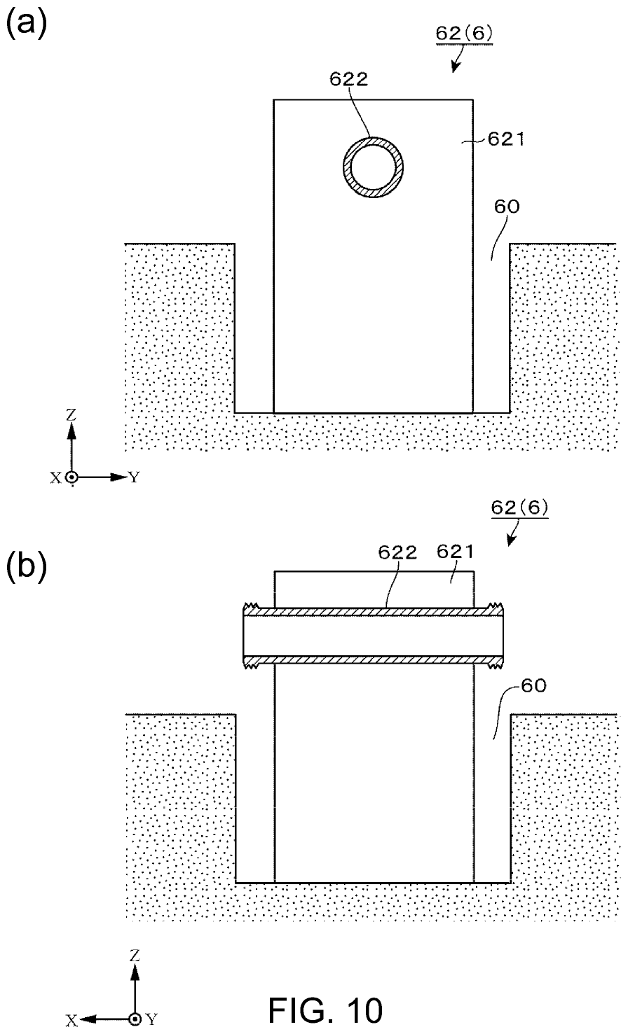

After the piping portion 622 having a preset diameter and a preset length is formed, the foundation main part 621 is formed so as to be laminated to a preset higher height position. Through the operation performed through use of the 3D printer 1, as illustrated in (a) and (b) of FIG. 10, the foundation 62 with a flow path including the piping portion 622 can be integrally formed. Filling of the gap between the foundation 62 with a flow path and the side wall of the foundation hole 60 with earth and sand, and compaction are finally performed in a manner similar to that in the case of the RC structure foundation 61 described above.

After that, the piping 5 is connected to the piping portion 622 of the foundation 62 with a flow path, thereby being capable of laying the piping 5 without arranging the piping 5 at another position in a roundabout manner. Further, the piping portion 622 is formed integrally with the foundation 62 with a flow path as described above. Accordingly, as compared to a case in which the foundation 6 is formed through casting work under a state in which the piping 5 that is prepared in advance is arranged through the formwork, forming work of the foundation 62 with a flow path can be simplified.

The piping portion 622 formed in the foundation 62 with a flow path corresponds to a flow path through which fluid flows. The method for forming the flow path in the foundation 62 with a flow path is not limited to a case in which the piping portion 622 is made of a different material such as a metal material as in the case described with reference to FIG. 9 and FIG. 10. For example, when the foundation main part 621 made of concrete is formed through use of the main body 4a for concrete, a tubular cavity allowing the fluid to flow therethrough may be formed in the foundation main part 621, and the cavity may be used as a flow path.

Further, the foundation 6 is not limited to a solid structure in which an inside of the foundation main part 611 or 621 is filled with cement being a constituent material for the foundation main part 611 or 621 as illustrated in FIG. 7 or FIG. 10.

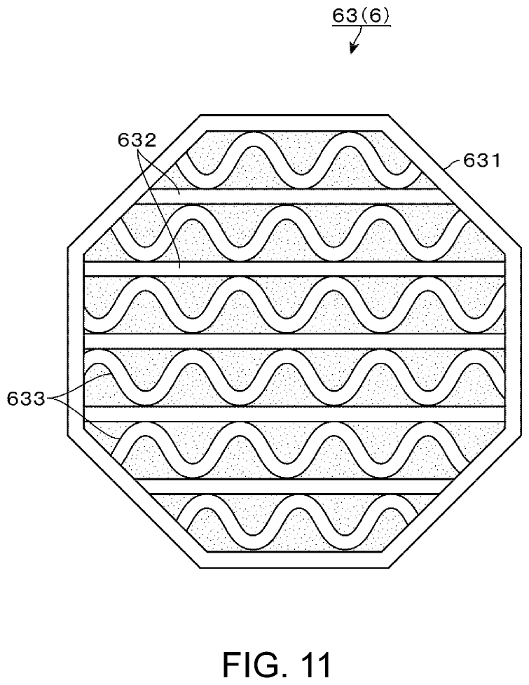

A large-sized device foundation 63 illustrated in plan views of FIG. 8 and FIG. 11 is a configuration example of the foundation 6 that does not have the solid structure. The large-sized device foundation 63 illustrated in FIG. 8 and FIG. 11 has a truss structure in which liner portions 632 and truss portions 633 are alternately arranged inside an outer peripheral wall 631 forming a side wall surface of the truss structure. The liner portions 632 each have a plate-like shape and extend in the up-and-down direction. The truss portions 633 each have a corrugated shape and extend in the up-and-down direction similarly to the liner portions 632. Gaps defined among the outer peripheral wall 631, the liner portions 632, and the truss portions 633 may be filled with earth and sand afterward.

In a case of adopting a sparse structure other than the solid structure, the present invention is not limited to the truss structure described above. There may also be formed the foundation 6 obtained by combining members based on various geometric patterns such as a honeycomb structure and a lattice structure. The foundations 6 obtained by combining members based on the geometric patterns can also be formed by laminating a constituent material through use of the printer main body 4.

Further, a foundation main part of the sparse structure may be formed through combination with the reinforcing bar members 612 illustrated in FIG. 7 or the piping portion 622 illustrated in FIG. 10.

According to the method for manufacturing the foundation 6 of the LNG plant in the embodiment of the present invention, the foundation 6 is manufactured through use of the 3D printer 1. Thus, manufacture of each foundation 6 is automated. Accordingly, forming work of the foundation 6 can be performed efficiently while work performed by construction workers is reduced and safety is improved.

In particular, the foundation 6 is a columnar structure extending in the up-and-down direction. Accordingly, among the structures provided in the LNG plant, the foundation 6 is suitable for manufacture performed by the 3D printer 1 in such a manner that a constituent material is successively accumulated from a lower layer side.

Here, in the example illustrated in FIG. 5 to FIG. 7, FIG. 9, and FIG. 10, there is exemplified the case in which the foundation 6 is manufactured directly in the foundation hole 60 without use of the formwork. However, such illustrated example does not deny the method of placing the formwork in the foundation hole 60 as needed and then forming the foundation 6 in the formwork through use of the printer main body 4.

Moreover, the 3D printer 1 configured to manufacture each foundation 6 is not limited to the case of using the extremely large type illustrated in FIG. 1 and FIG. 4. Each foundation 6 may be manufactured through use of the middle-sized 3D printer 1 including the support unit having a size large enough to straddle a region above the foundation hole 60.

Further, the foundation 6 manufactured by the method for manufacturing in the embodiment of the present invention may be, in addition to the above-mentioned LNG plant, a plant of a type among various types, such as a separation/recovery plant for separating/recovering a natural gas liquid, a petroleum refining plant for distilling and desulfurizing crude oil or various intermediate products, and a chemical plant for producing a petrochemical product, an intermediate chemical product, and a polymer.

Further, with regard to installation of the devices 2 on the foundations 6 described above, modules accommodating the devices 2 in the device racks 20 are built in, for example, some other place and conveyed to a location for installation, and the modules are connected to each other. In this manner, the plant may be constructed.

### REFERENCE SIGNS LIST

1 3D printer
2 device
20 device rack
21 large-sized device
3 pipe rack
4 printer main body
6 foundation
61 RC structure foundation
62 foundation with a flow path
63 large-sized device foundation

1. A method for manufacturing a foundation to be provided in a plant configured to process a fluid, the method comprising:
a step of forming a foundation, by a 3D printer, in a ground for installation of a device to be provided in the plant, or in a ground for installation of a framework structure configured to support the device or a piping through which the fluid flows,
wherein the foundation is configured to support the device or the framework structure.

2. The method for manufacturing a foundation according to claim 1, wherein
the foundation has a reinforced-concrete (RC) structure, and
wherein, in the step of forming a foundation, the foundation having the RC structure is integrally formed through different material joining of a concrete material and a metal material.

3. The method for manufacturing a foundation according to claim 1, wherein
in the step of forming a foundation, a flow path, through which the fluid to be used in the plant flows, is formed in the foundation.

4. The method for manufacturing a foundation according to claim 3, wherein
the flow path is made of a material different from a constituent material for the foundation, and
wherein the flow path is integrally formed in the foundation through different material joining of the constituent material for the foundation and a constituent material for the flow path performed through use of the 3D printer.

5. The method for manufacturing a foundation according to claim 1, wherein
an inside of the foundation has a sparse structure obtained by combining members in a geometric pattern.
